(19) United States
(12) Patent Application Publication
(10) Pub. No.: US 2017/0098018 A1
(43) Pub. Date: Apr. 6, 2017

(54) INFORMATION PROCESSING METHOD, INFORMATION PROCESSING APPARATUS, AND NON-TRANSITORY RECORDING MEDIUM STORING INFORMATION PROCESSING PROGRAM

(71) Applicant: FUJITSU LIMITED, Kawasaki-shi (JP)

(72) Inventors: MASAHIRO WATANABE, Kawasaki (JP); Takao Hirahara, Kawasaki (JP)

(73) Assignee: FUJITSU LIMITED, Kawasaki-shi (JP)

(21) Appl. No.: 15/276,854

(22) Filed: Sep. 27, 2016

(30) Foreign Application Priority Data
Oct. 5, 2015 (JP) 2015-197834

(51) Int. Cl. G06F 17/50; G06T 15/00; G06T 11/20; G06T 19/20

(52) U.S. Cl. CPC G06F 17/5009; G06T 19/20; G06T 15/00; G06T 11/206; G06T 2207/20024; G06T 2210/21; G06T 2219/2004

(57) ABSTRACT

An information processing method includes: acquiring, by a computer, three-dimensional data in which a value that varies based on an elapsed time from a start of a simulation is arranged; acquiring a value of a cross section of the three-dimensional data at each of the elapsed time; arranging the values of the cross section in chronological order in three-dimensional spacetime; and displaying arranged values as a three-dimensional image.

### CROSS-REFERENCE TO RELATED APPLICATION

This application is based upon and claims the benefit of priority of the prior Japanese Patent Application No. 2015-197834, filed on Oct. 5, 2015, the entire contents of which are incorporated herein by reference.

### FIELD

The embodiments discussed herein are related to display of three-dimensional data.

### BACKGROUND

Three-dimensional data that varies with time is displayed.

Related art techniques are disclosed in Japanese Laid-open Patent Publication No. 2003-334189.

### SUMMARY

According to an aspect of the embodiments, an information processing method includes: acquiring, by a computer, three-dimensional data in which a value that varies based on an elapsed time from a start of a simulation is arranged; acquiring a value of a cross section of the three-dimensional data at each of the elapsed time; arranging the values of the cross section in chronological order in three-dimensional spacetime; and displaying arranged values as a three-dimensional image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a hardware group of an information processing apparatus;

FIG. 2 depicts an example of data that is stored in a simulation DB;

FIG. 3A and FIG. 3B each depict an example of data that is stored in a rendering DB;

FIG. 4 illustrates an example of a three-dimensional model of simulation data;

FIG. 5A to FIG. 5C each depict an example of a pressure distribution of simulation data on a cross section to be measured;

FIG. 6 is an example of an enlarged view illustrating rendering coordinates of corners of a rendering screen;

FIG. 7 depicts an example of a rendered image;

FIG. 8 illustrates an example of a process of an information processing system;

FIG. 9 illustrates the example of the process of the information processing system;

FIG. 10 illustrates the example of the information processing system;

FIG. 11 illustrates an example of a hardware group of an information processing apparatus;

FIG. 12A and FIG. 12B each depict an example of data stored in a cross-section-to-be-measured DB;

FIG. 13 depicts an example of simulation data, a cross section to be measured, and a rendering screen;

FIG. 14 illustrates an example of a measured cross section and simulation coordinates;

FIG. 15A and FIG. 15B are each an example of an enlarged view in which part of simulation data is enlarged;

FIG. 16 illustrates an example of a process of the information processing system;

FIG. 17 illustrates the example of the process of the information processing system;

FIG. 18 depicts an example of a rendered image in which contour lines are drawn;

FIG. 19 illustrates an example of a process of the information processing system;

FIG. 20 illustrates an example of a method for calculating element values in a cross section to be measured;

FIG. 21A and FIG. 21B each depict a pressure distribution in the measured cross section;

FIG. 22 illustrates an example of a process of the information processing system;

FIG. 23 illustrates an example of a hardware group of an information processing apparatus; and

FIG. 24 illustrates an example of functional blocks of an information processing apparatus.

### DESCRIPTION OF EMBODIMENTS

For example, in some cases, it is difficult to understand the variations of a cross section of three-dimensional data.

For example, a method by which it is possible to understand the variations of a cross section of three-dimensional data may be provided.

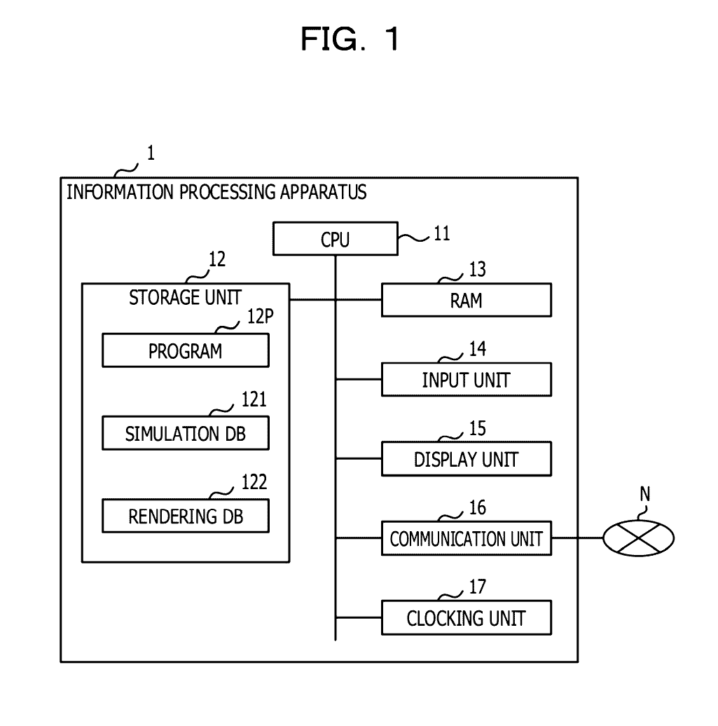

In the description given below, the horizontal, vertical, and depth directions are indicated by arrows arranged at the bottom of each drawing. FIG. 1 illustrates an example of a hardware group of an Information processing apparatus 1. The information processing apparatus includes a central processing unit (CPU) 11, a storage unit 12, a random access memory (RAM) 13, an input unit 14, a display unit 15, a communication unit 16, and a clocking unit 17.

The CPU 11 is coupled to each unit of hardware via a bus. The CPU 11 may include, for example, one or a plurality of CPUs, a multi-core CPU, or the like. The CPU 11 controls each unit of hardware in accordance with a program 12P stored in the storage unit 12.

The storage unit 12 may be, for example, a hard disk, a large memory, or the like. In the storage unit 12, various kinds of data that are to be used when the CPU 11 executes a process, a simulation DB 121, a rendering DB 122, and the program 12P are stored.

The RAM 13 may be, for example, static random access memory (SRAM), dynamic random access memory (DRAM), flash memory, or the like. The RAM 13 functions as a storage unit and temporarily stores various kinds of data that are produced when the CPU 11 executes various kinds of programs.

The input unit 14 is an input device such as a mouse or a keyboard, and transmits received operation information to the CPU 11. The display unit 15 displays image data transmitted from the CPU 11. The display unit 15 may be, for example, a liquid crystal screen. The communication unit 16 may be, for example, a wireless local area network (LAN) card, a cellular-phone communication module, or the like, and transmits and receives various kinds of information to and from other information processing apparatuses over a communication network N. The clocking unit 17 docks, for example, time at the current time point and, in response to a request of the CPU 11, outputs the docked result to the CPU 11.

The CPU 11 stores, in the simulation DB 121, simulation data (hereinafter referred to as three-dimensional data in some cases) in which element values that vary with time are arranged. The simulation data, for example, may be data that reproduces the motion of liquid, a heart, or the like. By operating the simulation data, the CPU 11 calculates a variation in physical quantity such as temperature or a pressure value generated by liquid, a heart, or the like at each elapsed time.

When a user wants, for example, to examine the distribution of pressure values of a wall surface with which tsunami waves have collided, the CPU 11 performs the following processing. The CPU 11 acquires pressure values on the wall surface of simulation data. The CPU 11 arranges the acquired pressure values on the wall surface in chronological order so as to generate a three-dimensionally rendered image, where the horizontal direction is the X-axis direction, the vertical direction is the Y-axis direction, and the depth direction represents time. The CPU 11 displays the generated rendered image in the display unit 15. Thus, the CPU 11 is able to display pressure values on the wall surface of simulation data in chronological order.

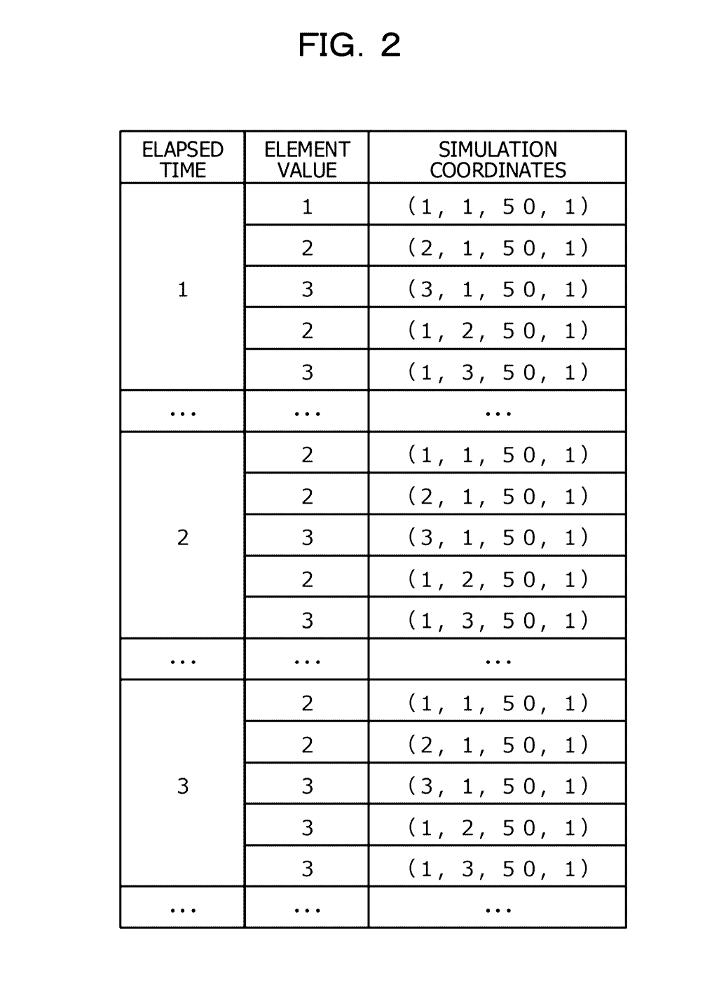

FIG. 2 depicts an example of data that is stored in the simulation DB 121. The simulation DB 121 may be a database that stores simulation data and the like. The simulation DB 121 includes an elapsed time column, an element value column, a simulation coordinates column, and the like. In the elapsed time column, an amount of elapsed time that indicates an amount of time that has elapsed since the start of a simulation is stored. The unit of an amount of elapsed time is, for example, second. Element values are stored in the element value column. The element value is, for example, a physical quantity such as temperature or a pressure value. In the simulation coordinates column, coordinates of simulation data are stored. Simulation coordinates and rendering coordinates may be represented in a four-dimensional Cartesian coordinate system. In the simulation coordinates column, for example, (1,1,50,1) is stored. The numbers of (1,1,50,1), in order from the left, represent the X-coordinate, the Y-coordinate, the Z-coordinate, and the W-coordinate. The W-coordinate is a coordinate introduced in order to translate the X-coordinate, the Y-coordinate, and the Z-coordinate. The units of the X-coordinate, the Y-coordinate, the Z-coordinate, and the W-coordinate are, for example, pixels.

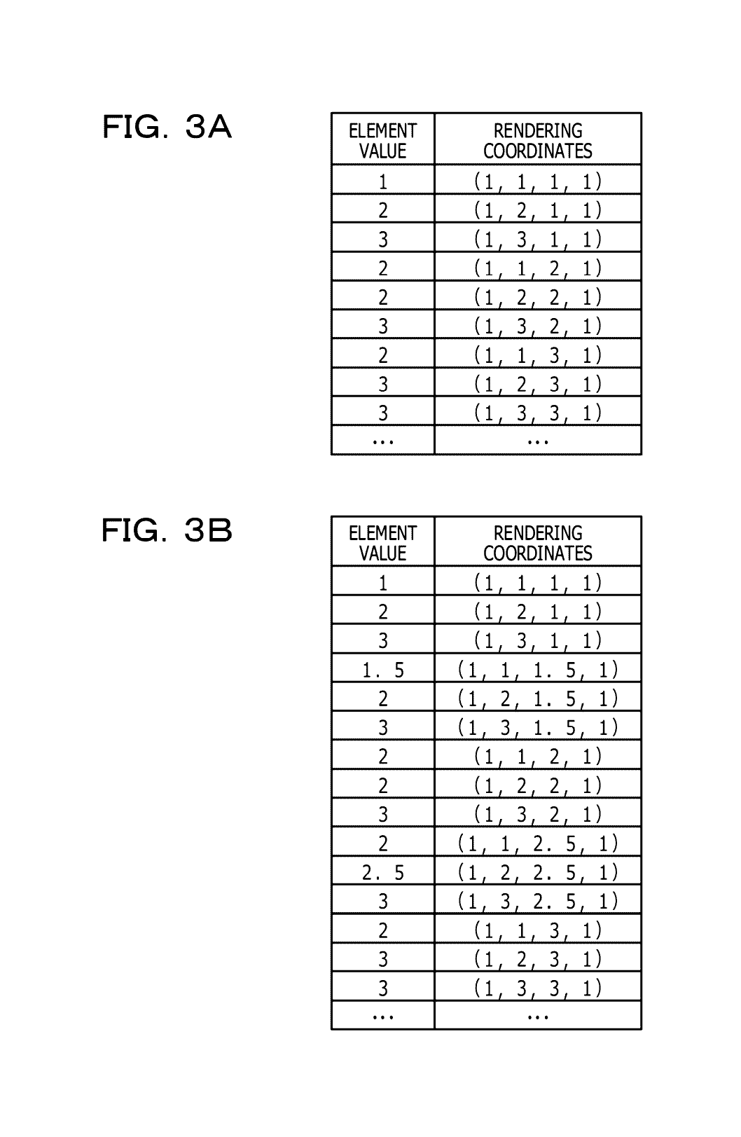

FIG. 3A and FIG. 3B each depict an example of data that is stored in the rendering DB 122. FIG. 3A is a diagram depicting an example of data that is stored in the rendering DB 122 before interpolation processing, in which values are interpolated between element values arranged in chronological order, is performed. FIG. 3B depicts an example of data that is stored in the rendering DB 122 after the interpolation processing is performed. The rendering DB 122 is a database that stores data for rendering. The rendering DB 122 includes an element value column, a rendering coordinates column, and the like. In the element value column, element values are stored. In the rendering coordinates column, rendering coordinates that represent the coordinates on a rendering screen are stored. The rendering screen is a screen on which element values are displayed in chronological order in three-dimensional spacetime. In the rendering coordinates column, for example, (1,1,1,1) is stored. The numbers of (1,1,1,1), in order from the left, represent the X-coordinate, the Y-coordinate, the elapsed time t, and the W-coordinate. Information of each column is associated with each other.

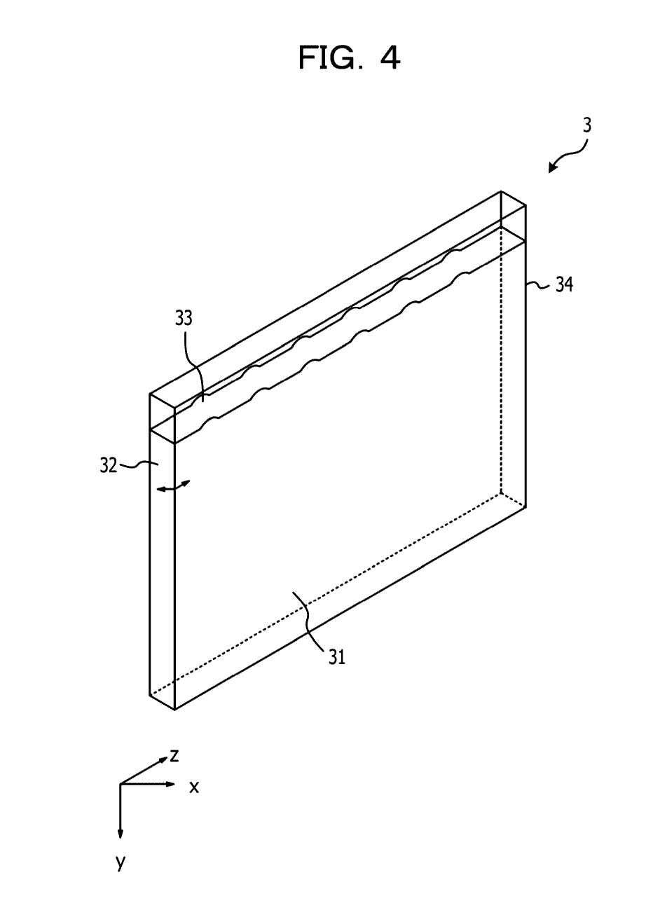

FIG. 4 illustrates an example of a three-dimensional model of simulation data. The horizontal direction, the vertical direction and the depth direction of FIG. 4 represent the X-direction, the Y-direction, and the Z-direction, respectively. As illustrated in FIG. 4, for example, simulation data may be data obtained by simulating the motion of liquid 31 with which the inside of a housing 3 is filled. A wave-making board 32 is installed on one wall surface of the housing 3. The wave-making board 32 is a board that generates waves on the liquid surface by vibrating in the X-direction. The behavior of the wave 33 is as follows. The CPU 11 causes the wave-making board 32 to vibrate for a certain time to generate the wave 33 in the liquid 31. The generated wave 33 travels in the positive Z-direction. The wave 33 collides with the wall surface 34 opposite to one wall surface on which the wave-making board 32 is installed, and then travels in the negative Z-direction, gradually slows down in the travelling direction, and disappears.

The CPU 11 calculates the values of pressure exerted on particles in the liquid 31 by the wall surface 34 or other particles (hereinafter referred to as element values in some cases). The CPU 11 places the calculated pressure values at the simulation coordinates where the particles are situated. The CPU 11 stores the pressure values, the simulation coordinates where the particles are situated, and elapsed times at which the pressure values are generated, in association with one another, in the simulation DB 121.

In the Information processing system, the user inputs the Z-coordinate=50 with the input unit 14. The CPU 11 receives input of the Z-coordinate=50. The CPU 11 generates a cross section to be measured for measuring element values, in the wall surface 34 where the Z-coordinate is set to 50 and the X-coordinate and the Y-coordinate are at an arbitrary point.

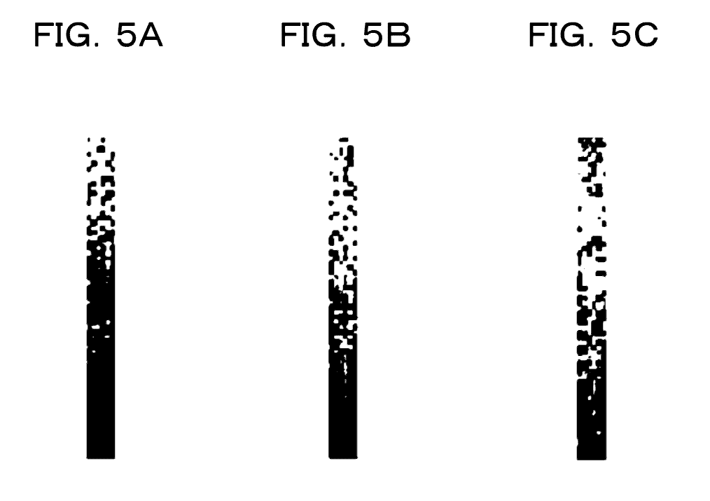

FIG. 5A to FIG. 5C each depict an example of a pressure distribution of simulation data on a cross section to be measured. FIG. 5A is a distribution diagram depicting a pressure distribution when the wave 33 on the cross section to be measured has reached the highest level. FIG. 5B is a distribution diagram depicting a pressure distribution when the wave 33 on the cross section to be measured has reached an intermediate level. FIG. 5C is a distribution diagram depicting a pressure distribution when the wave 33 on the cross section to be measured has reached the lowest level. White represents that pressure is low. Black represents that pressure is high. FIG. 5A to FIG. 5C depict that the pressure value moves downward in accordance with the height of the wave.

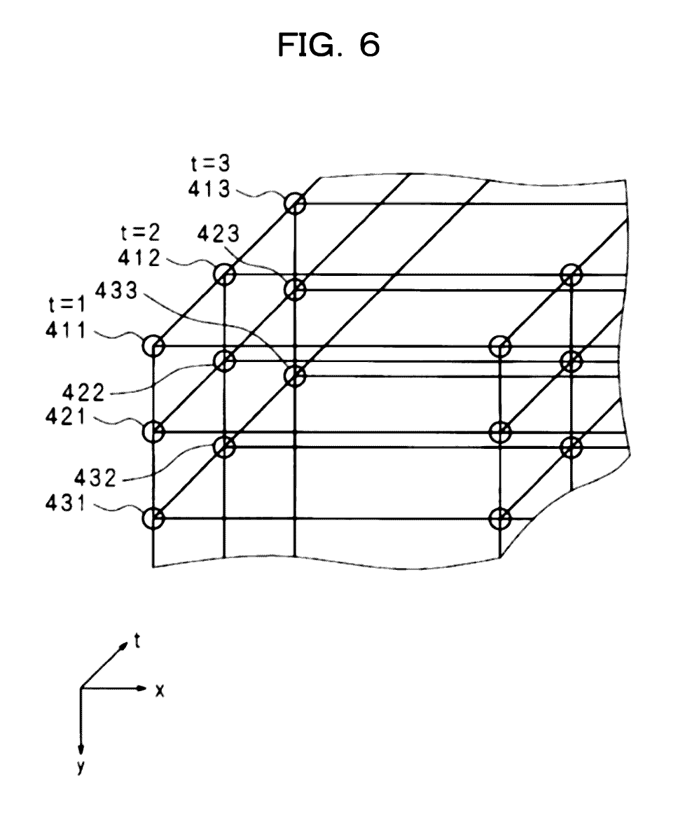

FIG. 6 is an example of an enlarged view illustrating rendering coordinates of a corner of a rendering screen. The horizontal direction, the vertical direction, and the depth direction of FIG. 6 represent the X-direction, the Y-direction, and the elapsed time t, respectively. The rendering screen includes rendering coordinates 411, 421, and 431 at (1,1,1,1), (1,2,1,1), and (1,3,1,1) within a coordinate plane at t=1. The rendering screen includes rendering coordinates 412, 422, and 432 at (1,1,2,1), (1,2,2,1), and (1,3,2,1) within a coordinate plane at t=2. The rendering screen includes rendering coordinates 413, 423, and 433 at (1,1,3,1), (1,2,3,1), and (1,3,3,1) within a coordinate plane at t=3.

The CPU 11 reads simulation data at t=1. The CPU 11 acquires an element value 1 at simulation coordinates (1,1,50,1). The CPU 11 acquires an element value 2 at simulation coordinates (1,2,50,1). The CPU 11 acquires an element value 3 at simulation coordinates (1,3,50,1). The CPU 11 places the element values 1, 2, and 3 at rendering coordinates 411, 421, and 431, respectively. Then, similar processing is performed for all the X-coordinates and Y-coordinates within the coordinate plane at t=1. The CPU 11 adds 1 second to the amount of the elapsed time t and reads simulation data at the elapsed time t=2. The CPU 11 acquires an element value 2 at the simulation coordinates (1,1,50,1), an element value 2 at the simulation coordinates (1,2,50,1), and an element value 3 at the simulation coordinates (1,3,50,1). The CPU 11 places the element values 2, 2, and 3 at the rendering coordinates 412, 422, and 432, respectively. Then, similar processing is performed for all the X-coordinates and Y-coordinates within the coordinate plane at t=2. The CPU 11 adds 1 second to the amount of the elapsed time t and reads simulation data at the elapsed time t=3. The CPU 11 acquires an element value 2 at the simulation coordinates (1,1,50,1). The CPU 11 acquires an element value 3 at the simulation coordinates (1,2,50,1). The CPU 11 acquires an element value 3 at the simulation coordinates (1,3,50,1). The CPU 11 places the element values 2, 3, and 3 at rendering coordinates 413, 423, and 433, respectively. Then, similar processing is performed for all the X-coordinates and Y-coordinates within the coordinate plane at t=3. The CPU 11 repeatedly performs similar processing until the completion time. The completion time may be an elapsed time at which rendering is completed.

The CPU 11 further performs interpolation processing. In the simulation data, element values are calculated every 1 second; however, there may be many cases where highly visible rendering is not achieved by calculation performed at a time interval of every 1 second. Therefore, the CPU 11 may calculate element values at a time interval shorter than the time interval of the simulation data.

After placing element values at rendering coordinates, the CPU 11 performs interpolation of element values at an elapsed time t=1.5 between the elapsed times t=1 and t=2. Interpolation of element values is calculated based on an interpolation function. The interpolation function is a function to interpolate values between elapsed times. The interpolation function may be, for example, a linear function with which values are uniquely determined based on the elapsed times before and after the target elapsed time and the element values.

As depicted in FIG. 3A, the element value at rendering coordinates (1,1,1,1) is 1, and the element value at rendering coordinates (1,1,2,1) is 2. The CPU 11 uses the elapsed time t=1, the elapsed time t=2, the elapsed time to be calculated t=1.5, the element value 1, and the element value 2 for the linear function, and thus calculates an element value 1.5. As depicted in FIG. 3B, the CPU 11 places the calculated element value 1.5 at rendering coordinates (1,1,1.5,1). Then, similar processing is performed for all the X-coordinates and Y-coordinates within the coordinate plane at t=1.5.

Next, the CPU 11 performs interpolation of element values at an elapsed time t=2.5 between the elapsed times t=2 and t=3. As depicted in FIG. 3A, the element value at the rendering coordinates (1,1,2,1) is 2 and the element value at the rendering coordinates (1,1,3,1) is 3. The CPU 11 uses the elapsed time t=2, the elapsed time t=3, an elapsed time to be calculated t=2.5, the element value 2, and the element value 3, and thus calculates an element value 2.5. As depicted in FIG. 3B, the CPU 11 places the calculated element value 2.5 at rendering coordinates (1,1,2.5,1). The CPU 11 then performs similar processing for all the X-coordinates and Y-coordinates within the coordinate plane at t=2.5 and repeatedly performs the processing until completion time. Once the completion time is reached, the CPU 11 stores the elapsed times, the element values, and the rendering coordinates in the rendering DB 122.

The CPU 11 acquires the largest value and the smallest value from among element values. The CPU 11 divides the element values based on the largest value and the smallest value. For example, the CPU 11 divides the element values based on the sizes of values. For example, when the largest value among element values is 5 and the smallest value is 1, the CPU 11 acquires the largest value 5 and the smallest value 1. The CPU 11 divides element values between the element value 1 and the element value 5 into n equal parts. For example, the CPU 11 calculates a difference between the largest value and the smallest value. The CPU 11 divides the calculated difference into n equal parts. The CPU 11 adds, to the smallest value, a value obtained by division of the difference into n equal parts, so that element values between the largest value and the smallest value are divided into n equal parts. For example, the CPU 11 divides the element values into parts “1 to 1.9”, “2 to 2.9”, “3 to 3.9”, and “4 to 5”.

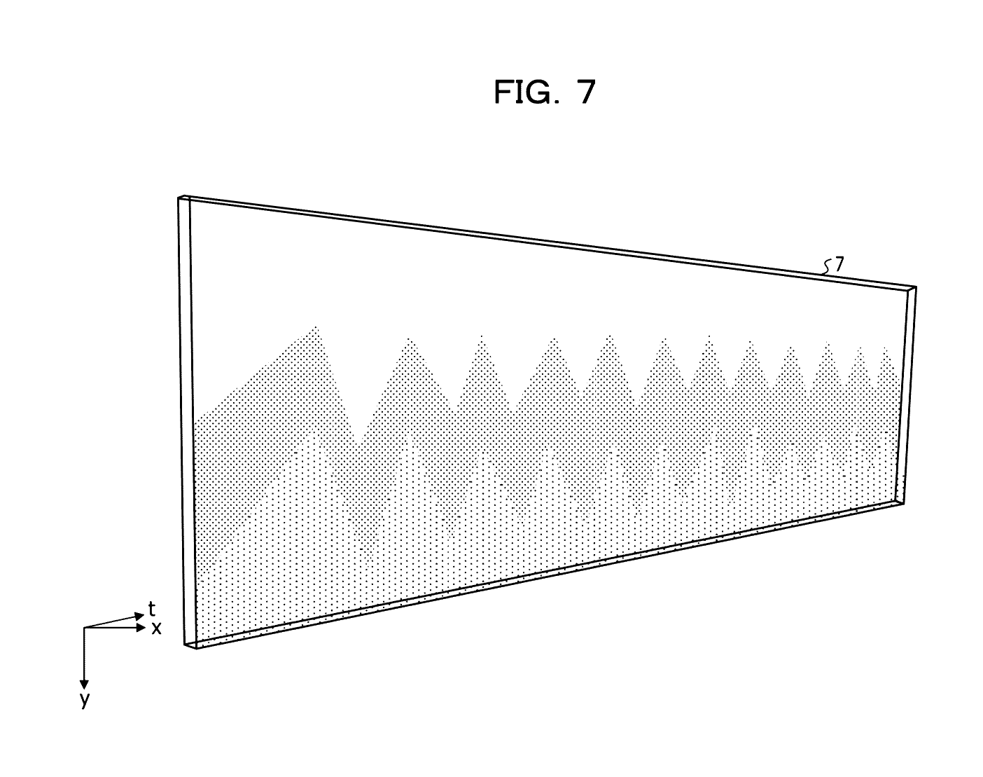

The CPU 11 classifies the divided element values by color. The CPU 11, for example, assigns red to the element values “1 to 1.9”. The CPU 11 assigns reddish purple to the element values “2 to 2.9”. The CPU 11 assigns purple to the element values “3 to 3.9”. The CPU 11 assigns violet to the element values “4 to 5”. The CPU 11 creates a rendered image 6 obtained by performing rendering based on the element values classified by color, and displays the created rendered image 6 on the display unit 15. FIG. 7 depicts an example of a rendered image. The horizontal direction, the vertical direction, and the depth direction of FIG. 7 represent the X-direction, the Y-direction, and the elapsed time t, respectively. As depicted in FIG. 7, the CPU 11 displays, on a rendering screen, the rendered image 6 in which a wavelike pressure distribution is created according to the elapsed time t.

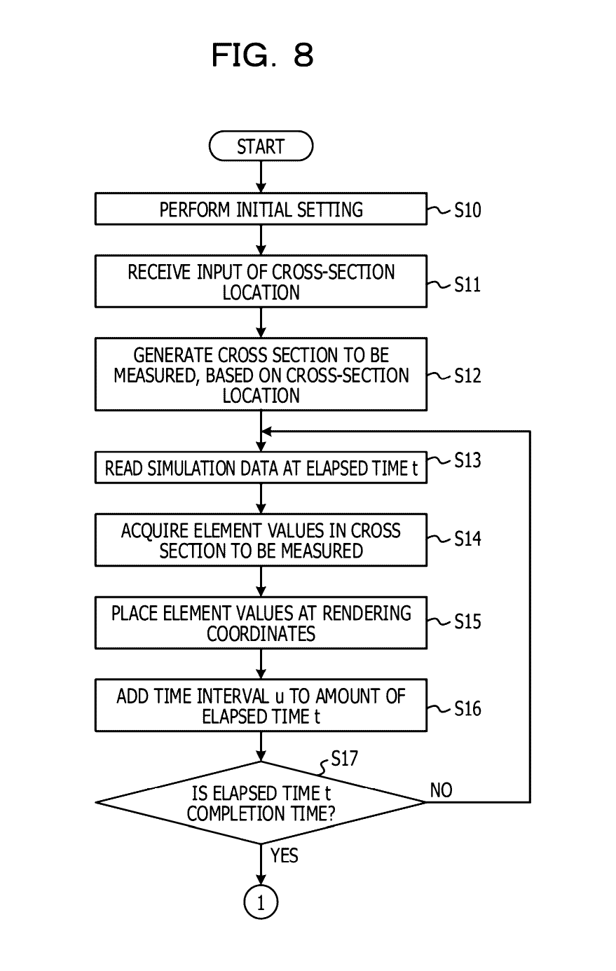

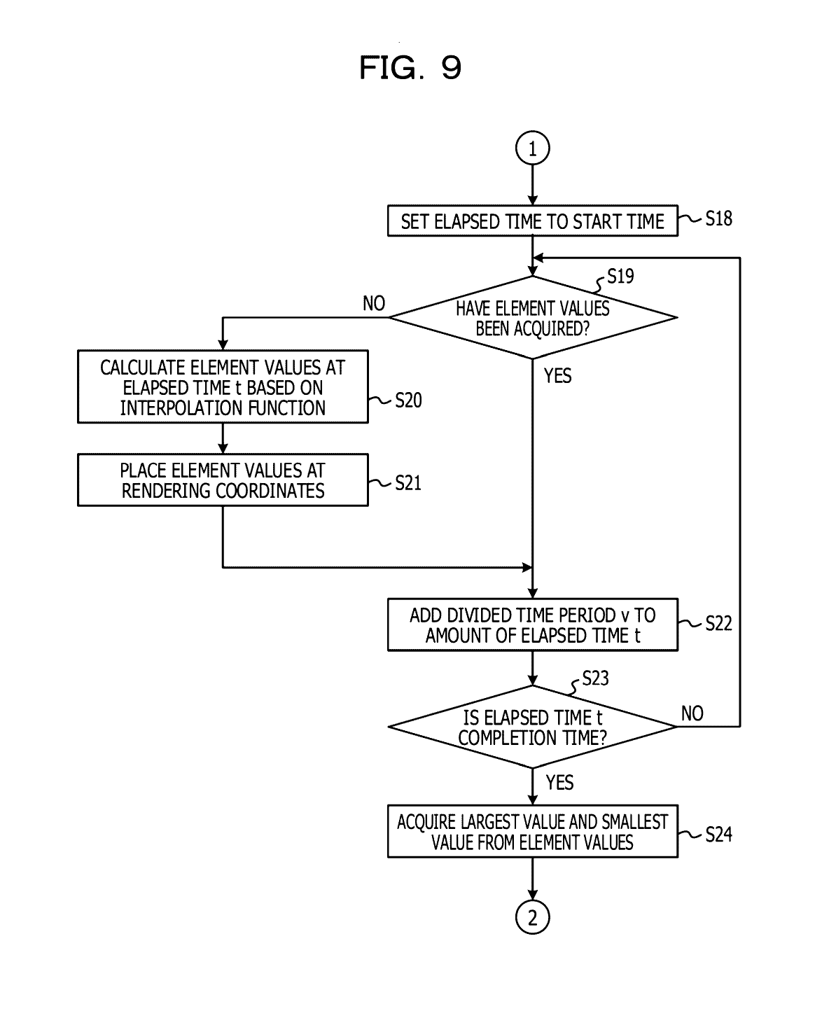

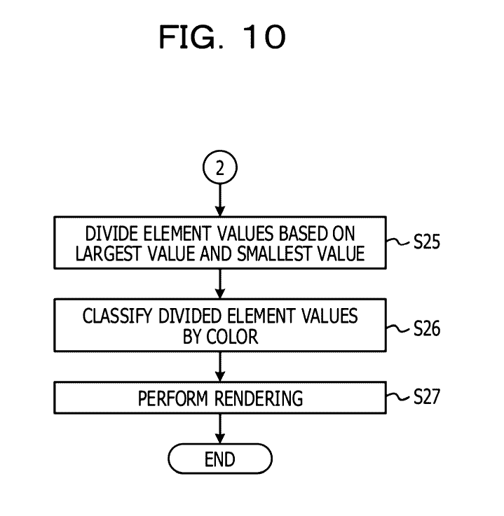

FIG. 8 to FIG. 10 illustrate an example of a process of an information processing system. The CPU 11 performs the initial setting (operation S10). The CPU 11 sets the elapsed time t to the start time. The CPU 11 sets the completion time. The CPU 11 sets a time interval u. The time interval u is, for example, a time interval between two elapsed times t stored in the simulation data. The CPU 11 sets a divided time period v. The divided time period is a time interval obtained by dividing the time interval u. The start time, the completion time, the time interval u, and the divided time period v may be stored in advance in the storage unit 12 and may be arbitrarily changed by the user. The CPU 11 receives input of a cross-section location (operation S11). The CPU 11 generates a cross section to be measured, based on the input cross-section location (operation S12). The CPU 11 reads simulation data at the elapsed time t (operation S13).

The CPU 11 acquires element values in the cross section to be measured (operation S14). The CPU 11 places the element values at rendering coordinates (operation S15). The CPU 11 adds the time interval u to the amount of the elapsed time t (operation S16). The CPU 11 determines whether or not the elapsed time t is the completion time (operation S17). If the CPU 11 determines that the elapsed time t is not the completion time (operation S17: No), the process returns to operation S13, where the process is repeatedly executed until the elapsed time t equals the completion time. If the CPU 11 determines that the elapsed time t is the completion time (operation S17: Yes), the CPU 11 sets the elapsed time t to the start time (operation S18).

The CPU 11 determines whether or not the element values of the cross section to be measured, at the elapsed time t, have already been acquired (operation S19). If the CPU 11 determines that the element values of the cross section to be measured, at the elapsed time t, have already been acquired (operation S19: Yes), the process proceeds to operation S22. If the CPU 11 determines that the element values of the cross section to be measured, at the elapsed time t, have not been acquired (operation S19: No), the CPU 11 calculates element values of the cross section to be measured, at the elapsed time t, based on an interpolation function (operation S20). The CPU 11 places the element values at rendering coordinates (operation S21). After completion of operation S19 or S21, the CPU 11 adds the divided time period v to the amount of the elapsed time t (operation S22). For example, the CPU 11 adds the divided time period v to the amount of elapsed time t in one case.

The CPU 11 determines whether or not the elapsed time t is the completion time (operation S23). If the CPU 11 determines that the elapsed time t is not the completion time (operation S23: No), the process returns to operation S19, where the process is repeatedly executed until the elapsed time t equals the completion time. If the CPU 11 determines that the elapsed time t is the completion time (operation S23: Yes), the CPU 11 acquires the largest value and the smallest value from among element values at rendering coordinates (operation S24).

The CPU 11 divides element values based on the largest value and the smallest value (operation S25). The CPU 11 classifies the divided element values by color (operation S26). For example, the CPU 11 associates the divided element values with colors based on the sizes of the element values. The CPU 11 renders the element values on the screen (operation S27), and the process is completed. For example, the CPU 11 displays element values as a three-dimensional image on the display unit 15.

According to one aspect, the variations of a cross section of three-dimensional data may be understood.

According to one aspect, calculating element values at the elapsed time t based on an interpolation function may lead to displaying the smooth rendered image 6.

According to one aspect, divided element values are classified by color, which may help to further understand the variations of the cross section.

According to one aspect, acquiring the largest value and the smallest value may lead to performing immediate appropriate division.

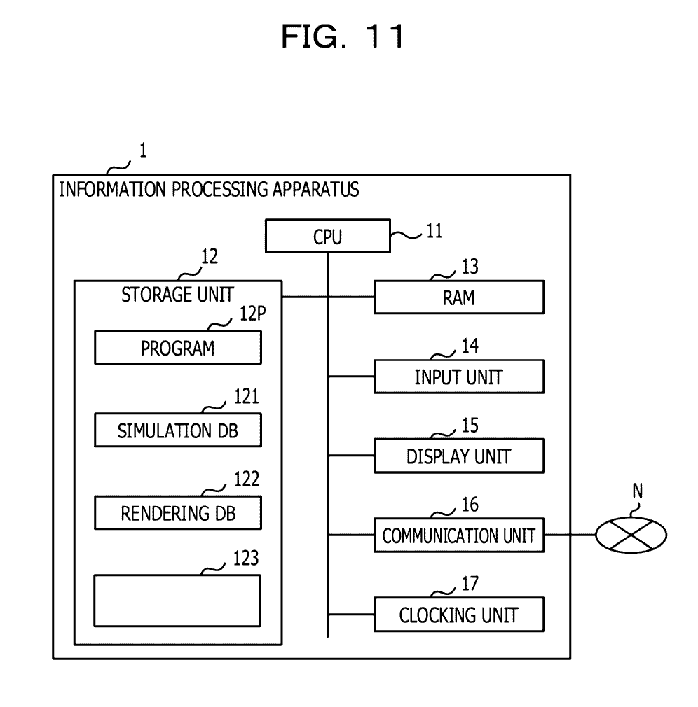

For example, three-dimensional data that simulates the motion of a heart may be used. In three-dimensional data, the shape of a heart is varied, and therefore the locations of element values arranged in the three-dimensional data also vary. Accordingly, when the user continues to acquire element values from the cross section to be measured at the cross-section location input by the user, the user may acquire element values that are different from the element values that the user desires to acquire. In order to acquire appropriate element values in accordance with variations in the three-dimensional data, the CPU 11 performs the following processing. When element values in the cross section to be measured and element values adjacent to the cross section to be measured are within a given range at each elapsed time, the CPU 11 regenerates a cross section to be measured so that the regenerated cross section to be measured includes adjacent locations representing the locations of the adjacent element values. The given range may be, for example, “0.5”. The CPU 11 acquires element values in the regenerated cross section to be measured to acquire the locations of appropriate element values in accordance with the shape of a heart. Hereinafter, configurations and operations other than the configurations and operations described in particular may be equivalent to the configurations and operations illustrated in FIG. 1 to FIG. 10, and description thereof may be omitted for the sake of conciseness. FIG. 11 illustrates a hardware group of the information processing apparatus 1. As illustrated in FIG. 11, the storage unit 12 of the information processing apparatus 1 includes a cross-section-to-be-measured DB 123.

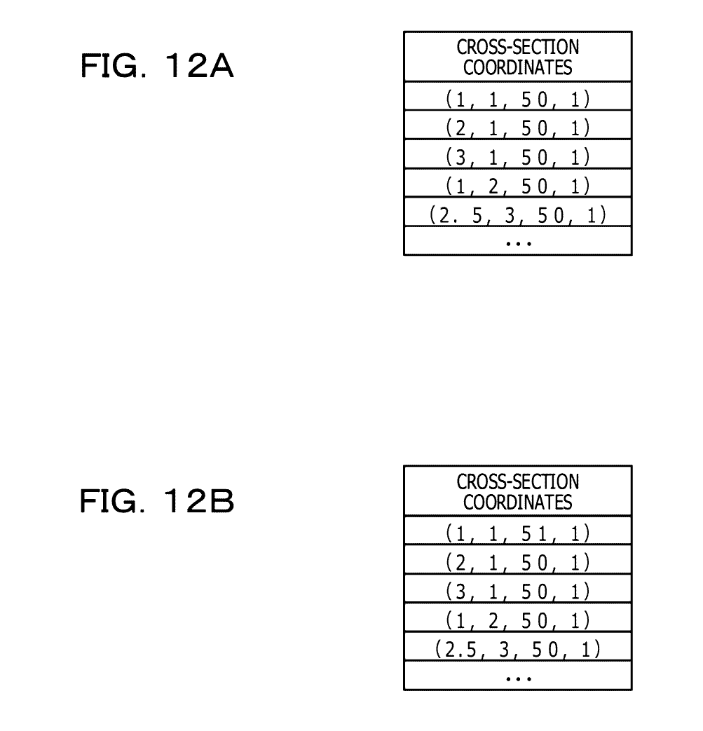

FIG. 12A and FIG. 12B each depict an example of data that is stored in the cross-section-to-be-measured DB 123. FIG. 12A depicts an example of data that is stored in the cross-section-to-be-measured DB 123 at the elapsed time t=1. FIG. 12B depicts an example of data that is stored in the cross-section-to-be-measured DB 123 at the elapsed time t=2. The cross-section-to-be-measured DB 123 is a database for storing coordinates of a cross section to be measured and the like. The cross-section-to-be-measured DB 123 includes a cross-section coordinates column and the like. In the cross-section coordinates column, cross-section coordinates representing the coordinates of a cross section to be measured in simulation data are stored. In the cross-section coordinates column, for example, (1,1,50,1) is stored. The numbers of (1,1,50,1), in order from the left, represent the X-coordinate, the Y-coordinate, the Z-coordinate, and the W-coordinate, respectively. Information in each column is associated with each other.

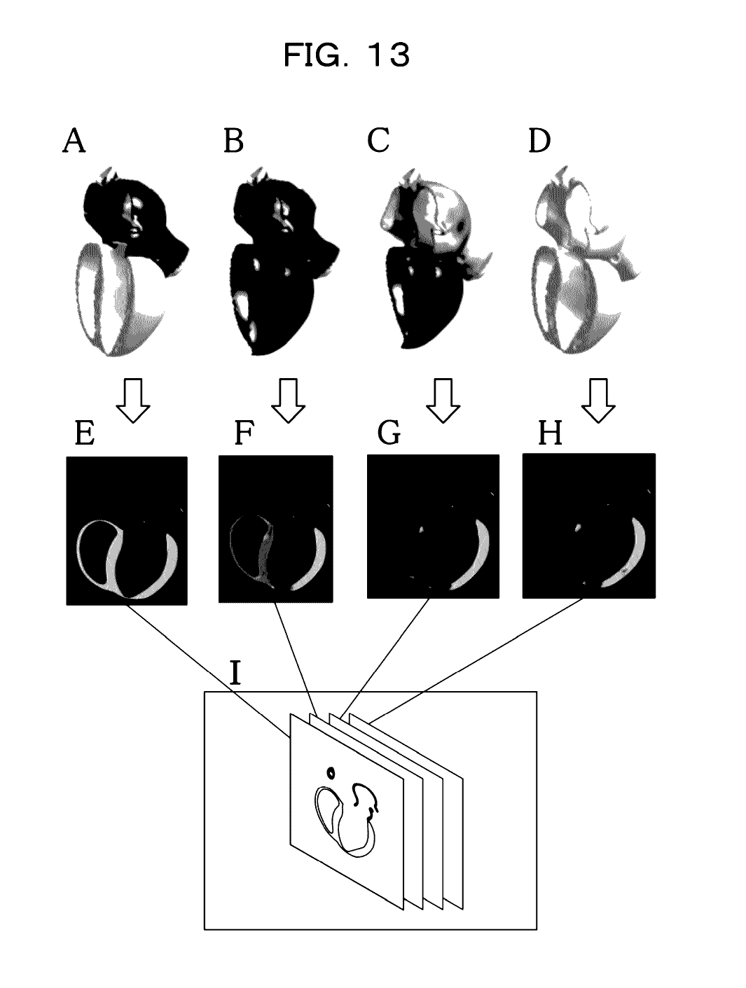

FIG. 13 depicts an example of simulation data, a cross section to be measured, and a rendering screen. For example, simulation data may be data that simulates the motion of a heart. A, B, C, and D depicted in FIG. 13 denote three-dimensional data of a heart at the elapsed times t=1, t=2, t=3, and t=4. E, F, G, and H depicted in FIG. 13 denote images of the cross section to be measured at the elapsed times t=1, t=2, t=3, and t=4. I depicted in FIG. 13 denotes a result obtained by rendering element values.

The CPU 11 calculates pressure values (hereinafter referred to as element values in some cases) of cardiac muscle. The CPU 11 places the calculated pressure values at simulation coordinates where cardiac muscle is present. The CPU 11 stores the pressure values, the simulation coordinates where cardiac muscle is present, and the elapsed times at which the pressure values are generated, in association with one another, in the simulation DB 121.

The user inputs a Z-coordinate=50 with the input unit 14 so as to specify the vicinity of the center of a heart as a cross-section location. The CPU 11 receives input of the cross-section location at the Z-coordinate=50. The CPU 11 generates a cross section to be measured for measuring the cross section of element values in the vicinity of the center of the heart. As depicted in FIG. 12A, the CPU 11 stores the coordinates of the generated cross section to be measured in the cross-section-to-be-measured DB 123.

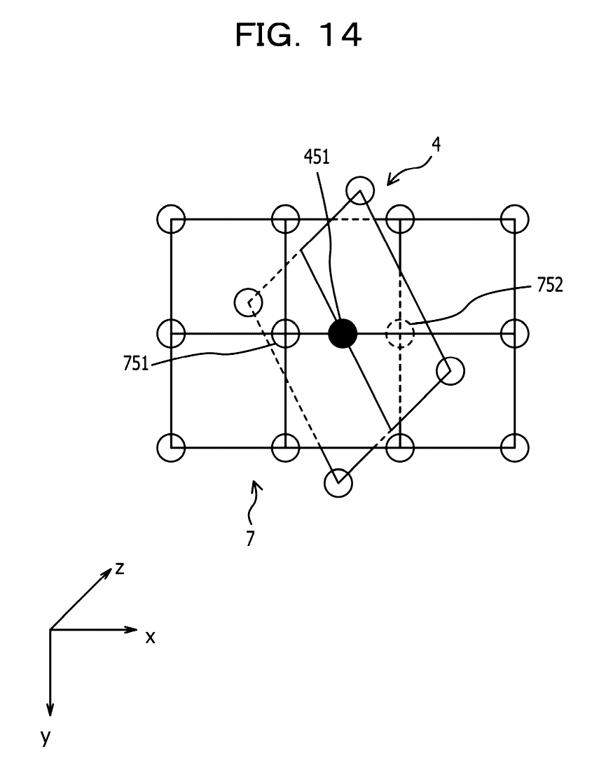

FIG. 14 illustrates an example of a cross section to be measured and simulation coordinates. The horizontal direction, the vertical direction, and the depth direction of FIG. 14 represent the X-direction, the Y-direction, and the Z-direction, respectively. Simulation data 7 includes, for example, simulation coordinates 751 and 752. The simulation coordinates 751 and 752 are (2,3,50,1) and (3,3,50,1), respectively. A cross section to be measured 4 includes cross-section coordinates 451 at which a joining line that joins the simulation coordinates 751 and 752 intersects. The coordinates of the cross-section coordinates 451 are (2.5,3,50,1).

For example, when the cross-section coordinates do not match the simulation coordinates, element values may be arranged on the cross section to be measured in accordance with the motion of three-dimensional data. Accordingly, the CPU 11 may perform processing as follows. The CPU 11 generates a joining line that joins simulation coordinates. When the cross section to be measured 4 intersects the joining line, the CPU 11 acquires element values of the simulation coordinates located at both ends of the joining line. The CPU 11 arranges, at the intersection between the cross section to be measured and the joining line, a value obtained by adding together a plurality of acquired element values and dividing the sum by 2. For example, the element value placed at the simulation coordinates 751 at the elapsed time t=1 may be 1, and the element value placed at the simulation coordinates 752 at the elapsed time t=1 may be 2. In this case, the CPU 11 places an element value 1.5 at the cross-section coordinates 411 located at the middle point of the simulation coordinates 751 and 752.

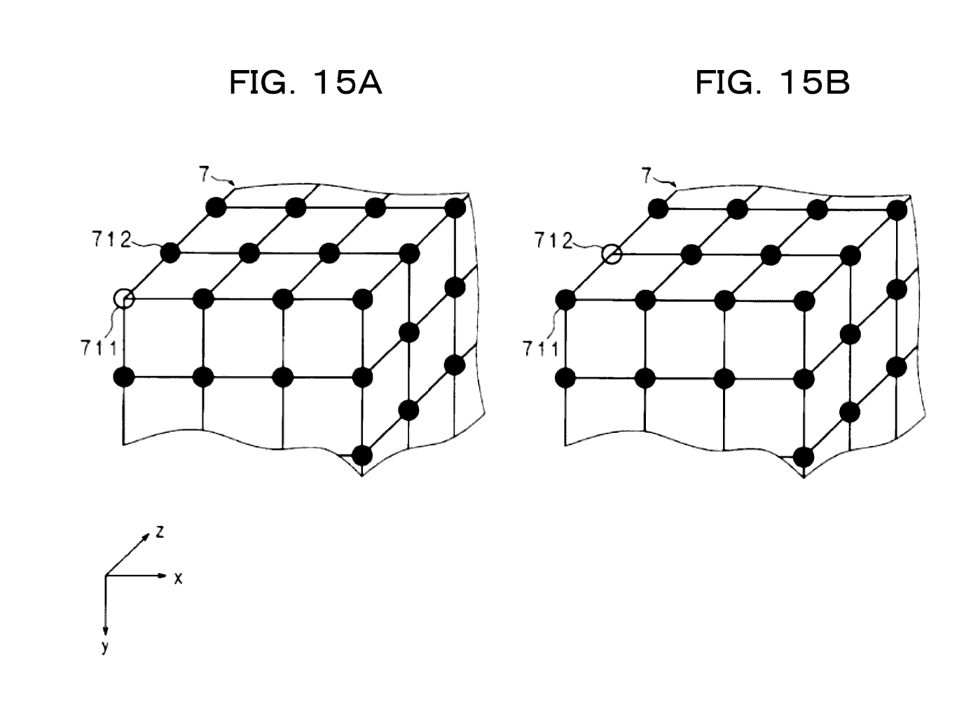

FIG. 15A and FIG. 15B each illustrate an enlarged view in which part of the simulation data 7 is enlarged. The horizontal direction, the vertical direction, and the depth direction of FIG. 15 represent the X-direction, the Y-direction, and the Z-direction, respectively. FIG. 15A is an enlarged view in which part of the simulation data 7 at the elapsed time t=1 is enlarged. FIG. 15B is an enlarged view in which part of the simulation data 7 at the elapsed time t=2 is enlarged. The simulation data 7 includes simulation coordinates 711 located at (1,1,50,1), and simulation coordinates 712 that are adjacent in the Z-direction to the simulation coordinates 711 and are located at (1,1,51,1). The simulation coordinates illustrated in FIG. 15A and FIG. 15B are displayed in black color and white color. The black color in the drawing represents an element value 2, and the white color represents an element value 1. The element value placed at the simulation coordinates 711 illustrated in FIG. 15A is 1, and the element value placed at the simulation coordinates 712 is 2. The element value placed at the simulation coordinates 711 illustrated in FIG. 15B is 2, and the element value placed at the simulation coordinates 712 is 1. Accordingly, because the element value 1 in the cross section to be measured and the element value 1 adjacent to the cross section are within the given range “0.5”, the CPU 11 determines that the element value 1 has moved from the simulation coordinates 711 to the simulation coordinates 712. As depicted in FIG. 12B, the CPU 11 overwrites the coordinates in the first row of the cross-section-to-be-measured DB 123 with the simulation coordinates 712. The CPU 11 adds 1 second to the amount of elapsed time, and then generates a cross section to be measured, based on the coordinates stored in the cross-section-to-be-measured DB 123, and acquires an element value from the simulation coordinates 712 at which the cross section to be measured has been generated. For example, the CPU 11 acquires an element value in the regenerated cross section at or after the elapsed time t=2. The CPU 11 performs the above processing at the time obtained by adding an arbitrary number of divided time periods to the amount of elapsed time.

When the shape of a heart varies at each elapsed time as depicted in A to D of FIG. 13, the CPU 11 regenerates a cross section to be measured at each elapsed time as depicted in E to H of FIG. 13. As illustrated in I of FIG. 13, the CPU 11 may arrange element values on the cross section to be measured, in chronological order, at rendering coordinates, and perform a process similar to the process illustrated in FIG. 8 to FIG. 10.

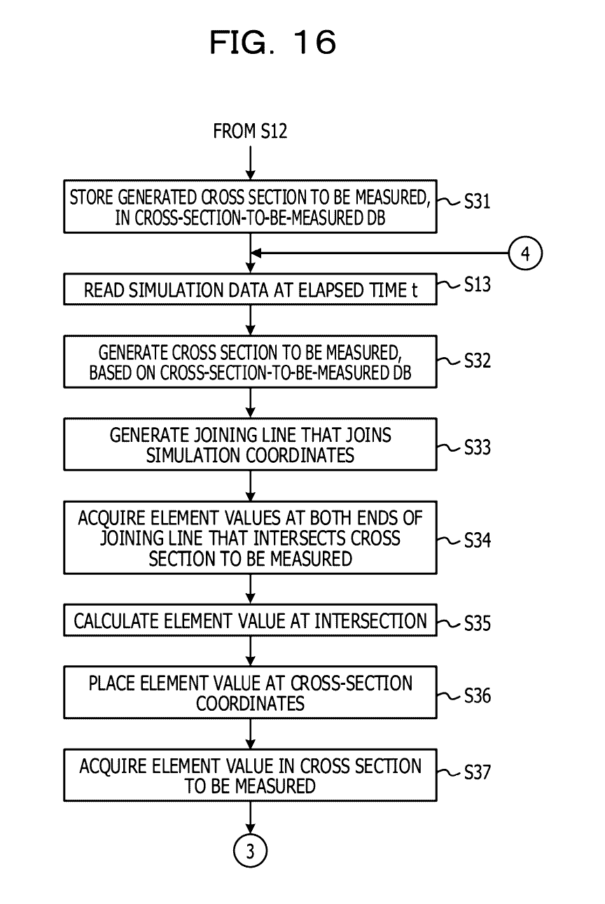

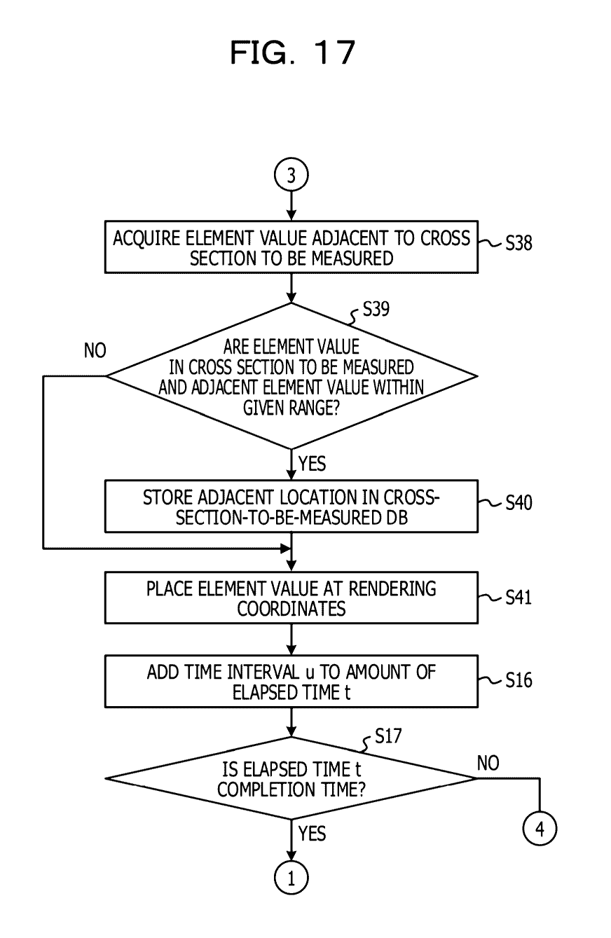

FIG. 16 and FIG. 17 illustrate an example of a process of an information processing system. Operations S10 to S27 are similar to the operations of the information processing system described above, and therefore description thereof may be omitted for the sake of conciseness. After completing operation S12, the CPU 11 stores the generated cross section to be measured, in the cross-section-to-be-measured DB 123 (operation S31), and the process proceeds to operation S13. After completing operation S13, the CPU 11 generates a cross section to be measured, based on the cross-section-to-be-measured DB 123 (operation S32).

The CPU 11 generates a joining line that joins simulation coordinates (operation S33). The CPU 11 acquires element values at both ends of the joining line that intersects the cross section to be measured (operation S34). The CPU 11 calculates an element value at the Intersection between the cross section to be measured and the joining line (operation S35). For example, the CPU 11 calculates a value by adding together a plurality of acquired element values and dividing the sum by 2. The CPU 11 places the element value at the cross-section coordinates of the Intersection (operation S36). The CPU 11 acquires an element value in the cross section to be measured (operation S37). The CPU 11 acquires an element value adjacent to the cross section to be measured (operation S38).

The CPU 11 determines whether or not the element value in the cross section to be measured and the element value adjacent to the cross section to be measured are within the given range (operation S39). If the CPU 11 determines that the element values are not within the given range (operation S39: No), the process proceeds to operation S41. If the CPU 11 determines that the element values are within the given range (operation S39: Yes), the CPU 11 stores the adjacent location in the cross-section-to-be-measured DB 123 (operation S40).

The CPU 11 places the element values of the cross-section coordinates at rendering coordinates (operation S41), and the process proceeds to operation S17.

According to one aspect, tracing element values within the given range may lead to displaying the appropriate rendered image 6.

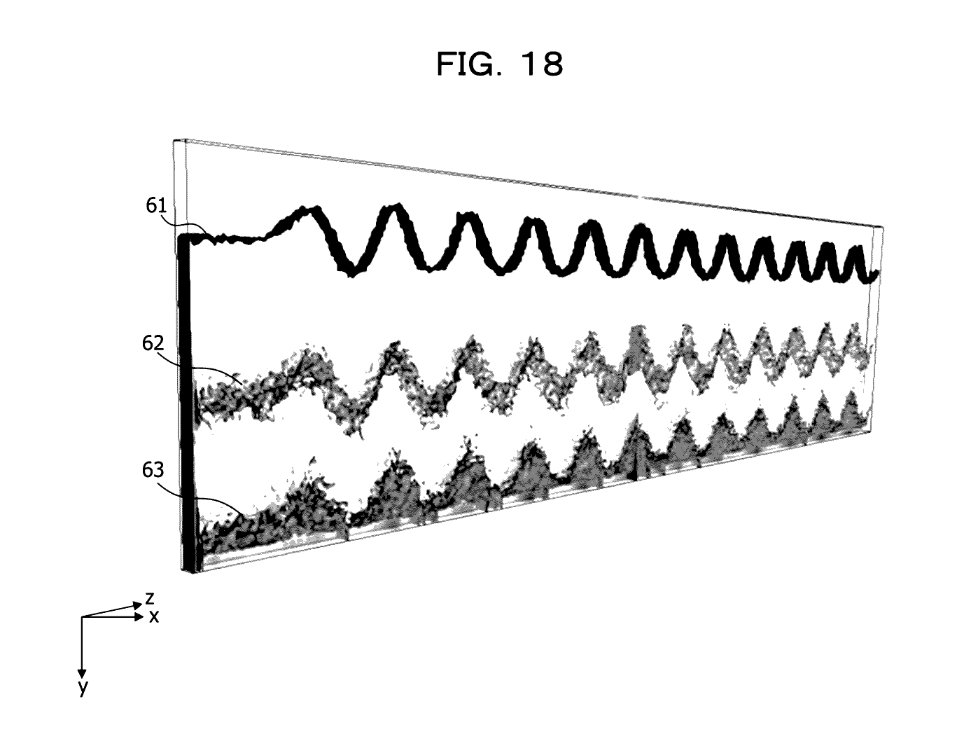

For example, the rendered image 6 in which contour lines are drawn may be displayed. Hereinafter, configurations and operations other than the configurations and operations described in particular may be equivalent to the configurations and operations illustrated in FIG. 1 to FIG. 10, and description thereof may be omitted for the sake of conciseness. In FIG. 18, an example of a rendered image in which contour lines are drawn is depicted. As depicted in FIG. 18, the rendered image 6 includes contour lines 61, 62, and 63. The contour line 61 is a contour line representing the largest value among pressure values. The contour line 62 is a contour line representing a value that is in the middle of the largest and smallest values. The contour line 63 is a contour line representing the smallest value among pressure values.

After classifying the divided element values by color, the CPU 11 extracts the largest value, the smallest value, and the value that is in the middle of the largest and smallest values, from the rendering DB 122. The CPU 11 assigns yellow to the coordinates of the largest value. The CPU 11 assigns yellow green to the coordinates of the value that is in the middle of the largest and smallest values. The CPU 11 assigns green to the coordinates of the smallest value. Colors may be assigned in any manner. The CPU 11 renders the element values on a screen.

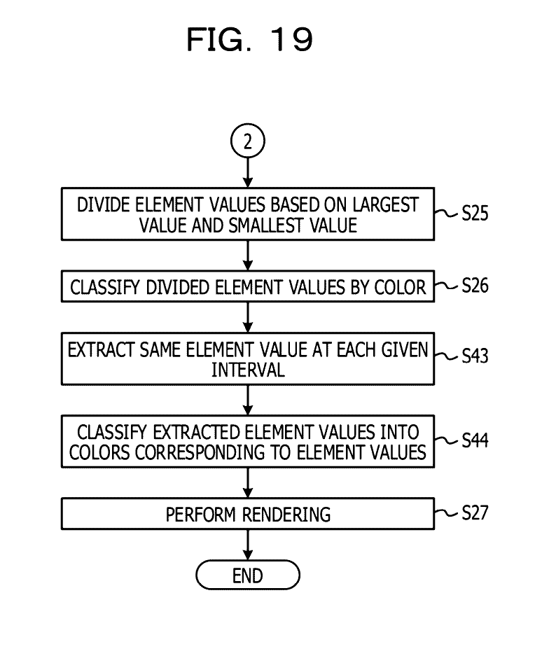

FIG. 19 illustrates an example of a process of the information processing system. Operations S10 to S27 are substantially the same as the above process of the information processing system, and therefore description thereof may be omitted for the sake of conciseness. After completing operation S26, the CPU 11 extracts the same element value at each given Interval (operation S43). The given interval may have, for example, a value that is in the middle of the largest and smallest values. The CPU 11 classifies the extracted element values into colors corresponding to the element values (operation S44), and the process returns to operation S27.

According to one aspect, drawing contour lines may help to understand the spatial distribution of equal values.

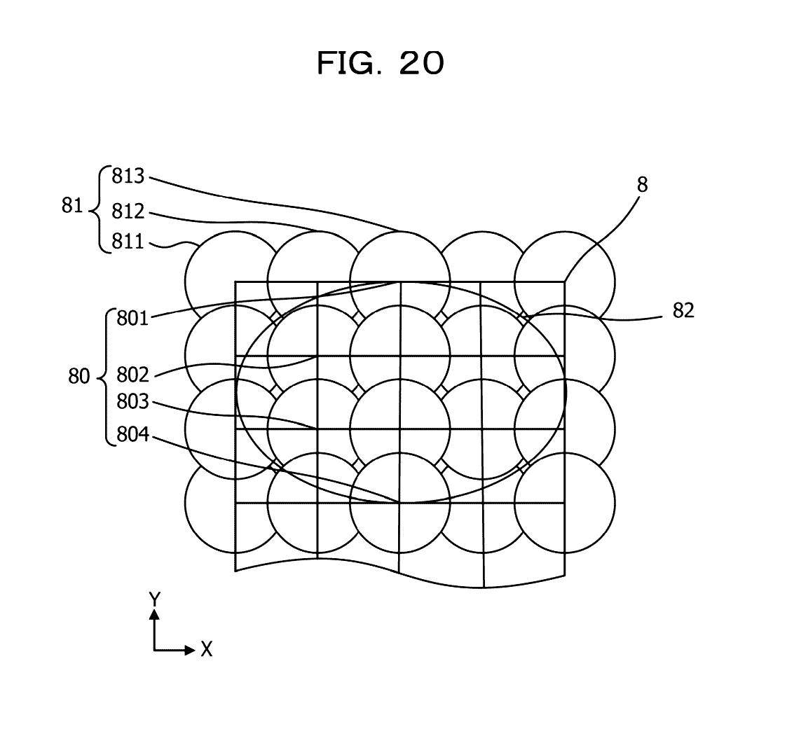

For example, applying a filter may lead to displaying a rendered image in which the distribution is made smooth. Hereinafter, configurations and operations other than the configurations and operations described in particular are substantially equivalent to the configurations or the process illustrated in FIG. 1 to FIG. 10, and description thereof may be omitted for the sake of conciseness. FIG. 20 illustrates an example of a method for calculating element values in a cross section to be measured 8. The vertical direction of FIG. 20 represents the Y-direction, and the horizontal direction represents the X-direction. The cross section to be measured 8 includes particles 811, 812, and 813 (hereinafter may be referred to collectively as particles 81 in some cases) placed at cross-section coordinates 801, 802, 803, and 804 (hereinafter may be referred to collectively as cross-section coordinates 80), and a filter 82 that covers part of the cross section to be measured 8.

The particle 81 may be, for example, spherical. There are overlapping portions of each of the particles 81. In an actual pressure distribution, the pressure of a portion where the particles 81 overlap is larger than the pressure of a portion where the particles 81 do not overlap. Therefore, the CPU 11 smoothens simulation data to make the pressure distribution appropriate. For example, the CPU 11 smoothens element values by applying the filter 82 to element values placed at the coordinates 80 within the filter 82. The filter 82 is a Gaussian filter, and forms an ellipse that is longer in the X-direction than in the Y-direction. The standard deviation in the Y-direction in the filer 82 is smaller than the standard deviation in the X-direction.

An element value is associated with each of the particles 81. The CPU 11 acquires the element values of the particles 81. The CPU 11, for example, multiplies the element value at the cross-section coordinates 801 by one third, the element value at the cross-section coordinates 802 by two third, the element value at the cross-section coordinates 803 by two third, and the element value at the cross-section coordinates 804 by one third, thus applying the filter 82 to the element values. The CPU 11 then performs similar processing to the cross-section coordinates 80 within the filter 82. The CPU 11 places the element values to which the filter 82 has been applied, at the cross-section coordinates.

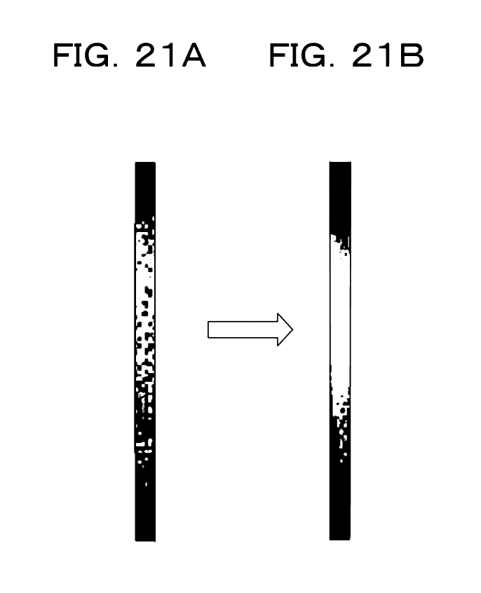

FIG. 21A and FIG. 21B each Illustrate an example of a pressure distribution in the cross section to be measured 8. FIG. 21A is a distribution diagram depicting a pressure distribution in the cross section to be measured 8 before a filter is applied. FIG. 21B is a distribution diagram depicting a pressure distribution in the cross section to be measured 8 after the filter has been applied. As depicted in FIG. 21A, element values are sparsely dotted at the central portion of the cross section to be measured 8 before the filter is applied. As depicted in FIG. 21B, it is understood that, in the central portion of the cross section to be measured 8 after the filter has been applied, the element values that have been sparsely dotted are smoothened.

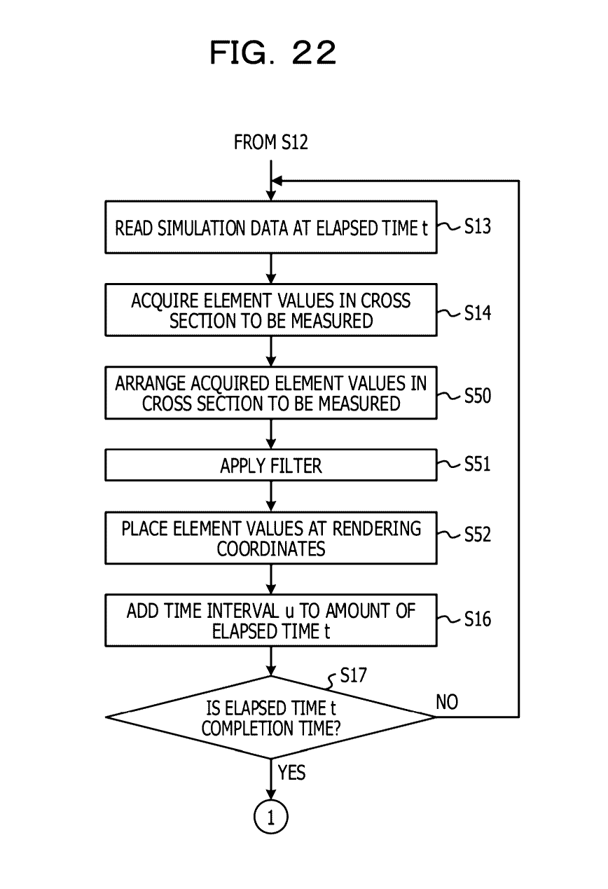

FIG. 22 illustrates an example of a process of the information processing system. Operations S10 to S27 are substantially the same as the information processing system described above, and therefore description thereof may be omitted for the sake of conciseness. After completing operation S14, the CPU 11 arranges the acquired element values in the cross section to be measured 8 (operation 550). The CPU 11 applies the filter 82 to the element values arranged in the cross section to be measured 8 (operation 551). The CPU 11 places the element values to which the filter 82 has been applied, at rendering coordinates (operation S552), and the process proceeds to operation S16.

According to one aspect, applying a filter may lead to placing suitable element values, in accordance with the density of particles, at rendering coordinates.

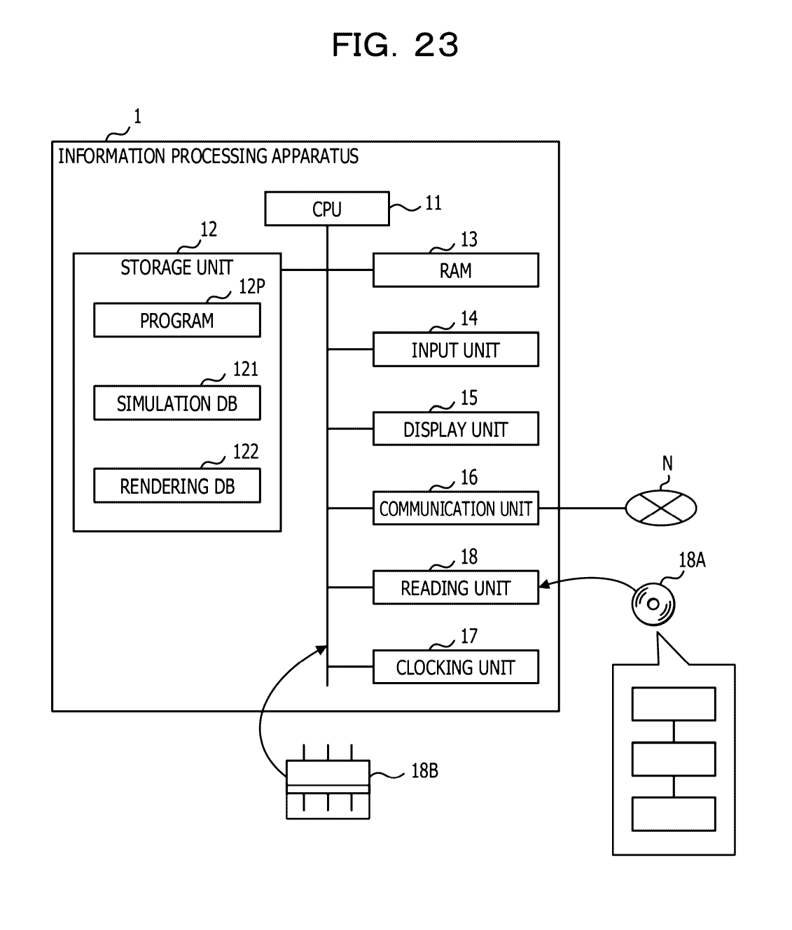

FIG. 23 illustrates an example of a hardware group of the information processing apparatus 1. Hereinafter, configurations and operations other than the configurations and operations described in particular are substantially equivalent to the configurations and operations illustrated in FIG. 1 to FIG. 10, and description thereof may be omitted for the sake of conciseness. The information processing apparatus 1 illustrated in FIG. 23 reads a program for executing various types of software processing described above from a portable recording medium 18A or semiconductor memory 18B, or downloads the program over a communication network N from another server (not illustrated). The program is installed as the program 12P, and is loaded onto the storage unit 12 and is executed. Therefore, the program may function as the information processing apparatus 1 described above.

A program for causing the information processing apparatus 1 to operate may be obtained by causing the reading unit 18, such as a disk drive, to read a portable recording medium 18A, such as a compact disc read-only memory (CD-ROM), a digital versatile disc (DVD), a memory card, or a universal serial bus (USB) memory, and be stored in the storage unit 12. The semiconductor memory 18B, such as flash memory, in which the program is stored may be mounted within the information processing apparatus 1. The communication unit 16 may be, for example, a wireless local-area network (LAN) card, a cellular-phone communication module, or the like, and is coupled over the communication network N to another server. The program may be downloaded from another server (not illustrated) coupled over the communication network N, such as the Internet, by the communication unit 16.

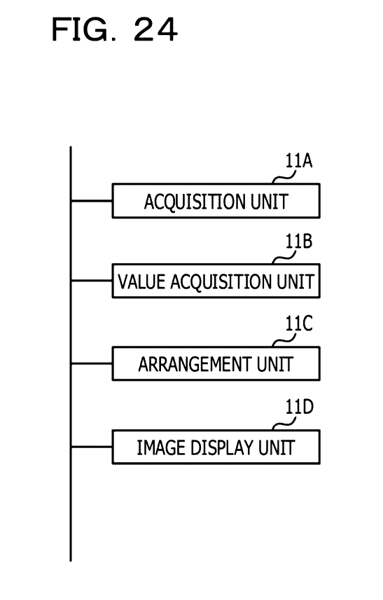

FIG. 24 illustrates an example of functional blocks of an information processing apparatus. By the CPU 11 executing the program 12P, the information processing apparatus 1 operates as follows. An acquisition unit 11A acquires three-dimensional data in which values varying at each elapsed time that has elapsed since a simulation started are arranged. A value acquisition unit 11B acquires values of a cross section of the three-dimensional data acquired by the acquisition unit 11A, at each elapsed time. An arrangement unit 11C arranges the values acquired by the value acquisition unit 11B in chronological order in three-dimensional spacetime. An image display unit 11D displays the values arranged by the arrangement unit 11C as a three-dimensional image.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method comprising:
acquiring, by a computer, three-dimensional data in which a value that varies based on an elapsed time from a start of a simulation is arranged;
acquiring a value of a cross section of the three-dimensional data at each of the elapsed time;
arranging the values of the cross section in chronological order in three-dimensional spacetime; and
displaying arranged values as a three-dimensional image.

2. The Information processing method according to claim 1, further comprising:
acquiring a value adjacent to the cross section at the elapsed time;
determining whether or not one of the values of the cross section and the value adjacent to the cross section are within a given range;
generating, when one of the values of the cross section and the value adjacent to the cross section are within the given range, a new cross section including a location adjacent to the cross section; and
acquiring a value of the new cross section at or after the elapsed time.

3. The information processing method according to claim 1, further comprising:
dividing one of the values of the cross section based on size of the one of the value of the cross section; and
displaying divided values in colors corresponding to the one of the values of the cross section.

4. The information processing method according to claim 1, further comprising:
extracting, from among the values of the cross section, equal values; and
displaying extracted values in a corresponding color.

5. The information processing method according to claim 4, further comprising:
acquiring a largest value and a smallest value from among the values of the cross section; and
dividing the values of the cross section based on the largest value and the smallest value.

6. The information processing method according to claim 1, further comprising:
calculating a divided time period obtained by dividing a gap between two elapsed times at which the values of the cross section have been acquired;
calculating an added time obtained by adding a number of the divided time periods to one of the two elapsed times; and
interpolating one of the values of the cross section at the added time based on an Interpolating function for interpolating the values of the cross section.

7. The information processing method according to claim 1, further comprising
applying a Gaussian filter for correction to the values of the cross section.

8. The information processing method according to claim 1, further comprising:
generating a coupling line that couples coordinates of the three-dimensional data; and
calculating, based on values of both ends of the coupling line, a value of an intersection between the coupling line and the cross section.

9. An information processing apparatus, comprising:
a processor configured to execute a information processing program; and
a memory configured to store the information processing program,
wherein the processor, based on the information processing program, performs operations of:
acquiring three-dimensional data in which a value that varies based on an elapsed time from a start of a simulation is arranged;
acquiring a value of a cross section of the three-dimensional data at each of the elapsed time;
arranging the values of the cross section in chronological order in three-dimensional spacetime; and
displaying arranged values as a three-dimensional image.

10. The information processing apparatus according to daim 9, wherein the processor:
acquires a value adjacent to the cross section at the elapsed time;
determines whether or not one of the values of the cross section and the value adjacent to the cross section are within a given range;
generates, when one of the values of the cross section and the value adjacent to the cross section are within the given range, a new cross section including a location adjacent to the cross section; and
acquires a value of the new cross section at or after the elapsed time.

11. The information processing apparatus according to claim 9, wherein the processor:
divides one of the values of the cross section based on size of the one of the value of the cross section; and
displays divided values in colors corresponding to the one of the values of the cross section.

12. The information processing apparatus according to daim 9, wherein the processor:
extracts, from among the values of the cross section, equal values; and
displays extracted values in a corresponding color.

13. The information processing apparatus according to daim 12, wherein the processor:
acquires a largest value and a smallest value from among the values of the cross section; and
divides the values of the cross section based on the largest value and the smallest value.

14. The information processing apparatus according to claim 9, wherein the processor:
calculates a divided time period obtained by dividing a gap between two elapsed times at which the values of the cross section have been acquired;
calculates an added time obtained by adding a number of the divided time periods to one of the two elapsed times; and
interpolates one of the values of the cross section at the added time based on an interpolating function for interpolating the values of the cross section.

15. The information processing apparatus according to daim 9, wherein the processor:
applies a Gaussian filter for correction to the values of the cross section.

16. The information processing apparatus according to claim 9, wherein the processor:
generates a coupling line that couples coordinates of the three-dimensional data; and
calculates, based on values of both ends of the coupling line, a value of an intersection between the coupling line and the cross section.

17. A non-transitory recording medium storing an Information processing program which causes a computer to execute operations, the operations comprising:
acquiring three-dimensional data in which a value that varies based on an elapsed time from a start of a simulation is arranged;
acquiring a value of a cross section of the three-dimensional data at each of the elapsed time;
arranging the values of the cross section in chronological order in three-dimensional spacetime; and
displaying arranged values as a three-dimensional image.

18. The non-transitory recording medium according to claim 17, further comprising:
acquiring a value adjacent to the cross section at the elapsed time;
determining whether or not one of the values of the cross section and the value adjacent to the cross section are within a given range;
generating, when one of the values of the cross section and the value adjacent to the cross section are within the given range, a new cross section including a location adjacent to the cross section; and
acquiring a value of the new cross section at or after the elapsed time.

19. The non-transitory recording medium method according to claim 17, further comprising:
dividing one of the values of the cross section based on size of the one of the value of the cross section; and
displaying divided values in colors corresponding to the one of the values of the cross section.

20. The non-transitory recording medium according to claim 17, further comprising:
extracting, from among the values of the cross section, equal values; and
displaying extracted values in a corresponding color.
